(19) United States
(12) Patent Application Publication
(10) Pub. No.: US 2025/0214430 A1
(43) Pub. Date: Jul. 3, 2025

(54) DISPLAY DEVICE AND DISPLAY METHOD

(71) Applicant: Panasonic Automotive Systems Co., Ltd., Kanagawa (JP)

(72) Inventors: Miori KONDO, Osaka (JP); Masaki KONTANI, Osaka (JP)

(21) Appl. No.: 19/001,823

(22) Filed: Dec. 26, 2024

(30) Foreign Application Priority Data
Dec. 28, 2023 (JP) 2023-222604
Sep. 30, 2024 (JP) 2024-171034

(51) Int. Cl. B60K 35/22; B60K 35/60; B60K 35/81

(52) U.S. Cl. CPC B60K 35/22; B60K 35/60; B60K 35/81; B60K 2360/782

(57) ABSTRACT

A display device according to the present disclosure includes a display unit and a control unit. The display unit is disposed on an operation unit of a steering device. The control unit is electrically connected to the display unit, and controls a display mode of the display unit according to a temperature of the operation unit.

### CROSS-REFERENCE TO RELATED APPLICATIONS

This application is based upon and claims the benefit of priority from Japanese Patent Application No. 2023-222604, filed on Dec. 28, 2023 and Japanese Patent Application No. 2024-171034, filed on Sep. 30, 2024; the entire contents of which are incorporated herein by reference.

### FIELD

Embodiments described herein relate generally to a display device and a display method.

### BACKGROUND

JP 2002-096739 A discloses a steering heater including therein a heater device that heats a steering wheel. Such a steering heater is mounted for the purpose of heating the steering wheel to a temperature suitable for a gripping operation by a driver in order to comfortably drive a vehicle when the vehicle is used under a low-temperature environment such as winter.

However, in the conventional technique, it is not possible to visually confirm whether the current temperature situation of the steering wheel is a temperature suitable for gripping, and there is room for improvement from the viewpoint of convenience of the driver.

### SUMMARY

A display device according to an embodiment of the present disclosure includes a display unit and a control unit. The display unit is disposed on an operation unit of a steering device. The control unit is electrically connected to the display unit, and controls a display mode of the display unit according to a temperature of the operation unit.

### BRIEF DESCRIPTION OF THE DRAWINGS

FIG. 1 is a front view illustrating an example of a steering wheel with a display device according to a first embodiment;

FIG. 2 is a front view illustrating another example of the steering wheel with the display device according to the first embodiment;

FIG. 3 is a diagram illustrating an example of a configuration of the display device according to the first embodiment;

FIG. 4 is a diagram illustrating an example of a hardware configuration of a control unit according to the first embodiment;

FIG. 5 is a diagram illustrating an example of a functional configuration of the control unit according to the first embodiment;

FIG. 6 is a flowchart illustrating an example of operations of the display device according to the first embodiment;

FIG. 7 is a diagram illustrating an example of behavior of the display device when gripping the steering wheel according to the first embodiment;

FIG. 8 is a diagram illustrating an example of a state in which a light emission color of the display device changes according to the first embodiment;

FIG. 9 is a diagram illustrating an example of a state in which a light emission area of the display device changes according to the first embodiment;

FIG. 10 is a diagram illustrating an example of a state in which characters to be displayed by light emission of the display device change according to the first embodiment;

FIG. 11 is a flowchart illustrating an example of the operation of the display device in a case where it is determined that a predetermined time has elapsed since the heating is completed according to a modification of the first embodiment;

FIG. 12 is a diagram illustrating an example of a case where a temperature state is displayed on a meter of the vehicle according to the first embodiment;

FIG. 13 is a flowchart illustrating an example of an operation of the display device in a case where the temperature is displayed from the elapsed time according to a second embodiment;

FIG. 14 is a diagram illustrating an example of a relationship between a lapse of time and a state change of light emission according to the second embodiment;

FIG. 15 is a flowchart illustrating an example of an operation of the display device in the case of calculating a heating time according to a third embodiment;

FIG. 16 is a flowchart illustrating an example of a display operation of the display device in the summer season according to a fourth embodiment;

FIG. 17 is a flowchart illustrating an example of a processing operation of performing actual temperature display on another display unit in a case where a grip of a driver is detected before a predetermined time elapses according to a fifth embodiment;

FIG. 18 is a flowchart illustrating an example of a processing operation of performing display on another display unit in a case where a grip of a driver is detected before heating is completed, according to a first modification of the fifth embodiment;

FIG. 19 is a flowchart illustrating an example of a processing operation of displaying a predicted temperature on another display unit in a case where a grip of a driver is detected before a predetermined time elapses according to a second modification of the fifth embodiment;

FIG. 20 is a flowchart illustrating an example of a processing operation of performing display on another display unit in a case where a grip of a driver is detected before an upper limit temperature is reached, according to a third modification of the fifth embodiment;

FIG. 21 is a flowchart illustrating an example of a processing operation of confirming whether a vehicle has traveled in a case where displaying on the display unit is stopped according to a sixth embodiment; and

FIG. 22 is a flowchart illustrating another example of a processing operation of confirming whether a vehicle has traveled in a case where displaying on the display unit is stopped according to a modification of the sixth embodiment.

### DETAILED DESCRIPTION

Hereinafter, one or more embodiments will be described with reference to the accompanying drawings. Numerical values, shapes, materials, constituent elements, arrangement positions and connection modes of the constituent elements, steps, the order of the steps, and the like in the embodiments disclosed below are all examples, and are not intended to limit the display device according to the present disclosure. In addition, in the drawings, the same reference numerals denote the same or substantially the same configurations, and the description thereof will be appropriately omitted. In the embodiments disclosed below, unnecessarily detailed description may be omitted. For example, description of well-known matters and description of substantially the same configuration may be omitted. This is to avoid hindering the understanding of those skilled in the art due to unnecessary redundancy of the description.

### First Embodiment

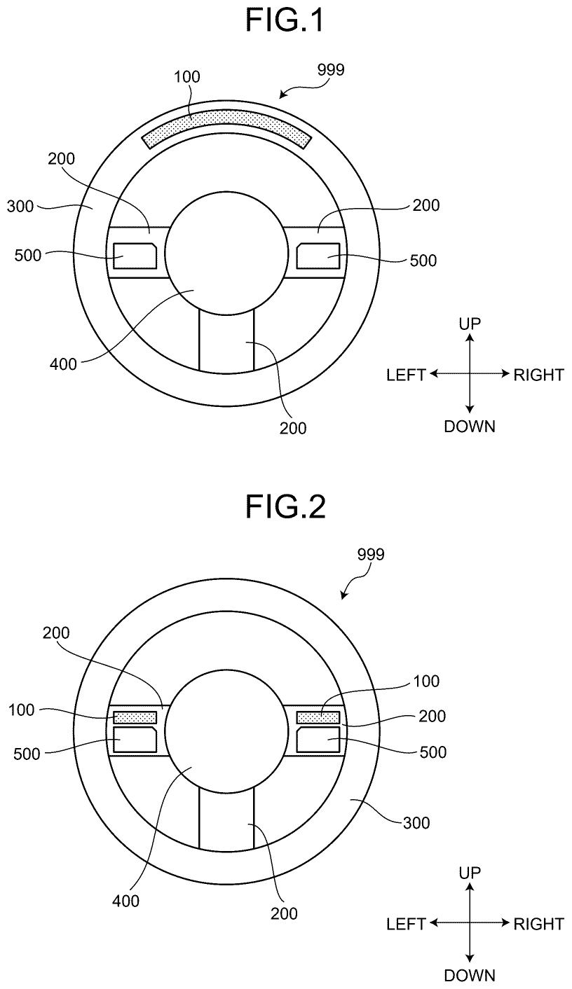

FIGS. 1 and 2 are front views illustrating an example of a steering wheel 999 including a display device 100 according to a first embodiment. The steering wheel 999 is an operation unit of a steering device for steering a vehicle, and is held by a driver during driving. In the present disclosure, in the steering wheel 999 (operation unit), a portion gripped by the driver during driving (a part or all of a rim 300) is referred to as a grip portion. The steering wheel 999 includes a rim 300 having, for example, a ring shape, a hub 400 disposed at a substantially center of a circular space formed inside the rim 300, and a spoke 200 formed in a substantially T shape connecting an inner peripheral surface of the rim 300 and the hub 400. As an example, the hub 400 supports the spokes 200. The spokes 200 support the rim 300. As another example, the hub 400 may independently support each of the spokes 200 and the rim 300. Note that the shape of the steering wheel 999 is not limited to a ring shape, and may be a D type or an H type.

Although the display device 100 is disposed on the rim 300 in FIG. 1 and is disposed on the spoke 200 in FIG. 2, the location where the display device 100 is disposed is not limited. For example, the display device 100 may be disposed in a portion of the hub 400. In FIG. 1, the display device 100 deformed (formed) along the ring shape of the rim 300 is disposed on the upper portion of the rim 300, and in FIG. 2, two substantially rectangular display devices 100 are disposed on the spokes 200 substantially parallel to the spokes 200, but the shape, the number, and the arrangement are not limited thereto. The display device 100 only needs to be provided so that the driver can visually recognize the current temperature situation of the steering wheel 999, and each of the shape, the number, and the arrangement can be freely determined. More specifically, a display unit described later included in the display device 100 may be disposed on the steering wheel 999. Note that the driver is a driver before touching the steering wheel 999, and is, for example, a driver seated on a driver's seat, but may be a driver who stands with a door opened before seating or performs a seating operation, or may be a driver who looks into the vehicle interior through a window. For example, a circular (for example, formed in an arc shape) display device 100 may be disposed below the rim 300. A steering switch 500 may be disposed on the spoke 200, and the display device 100 may be disposed in the steering switch 500. By mounting the display device 100 on the steering wheel 999, the current temperature situation of the steering wheel 999 can be intuitively visually recognized.

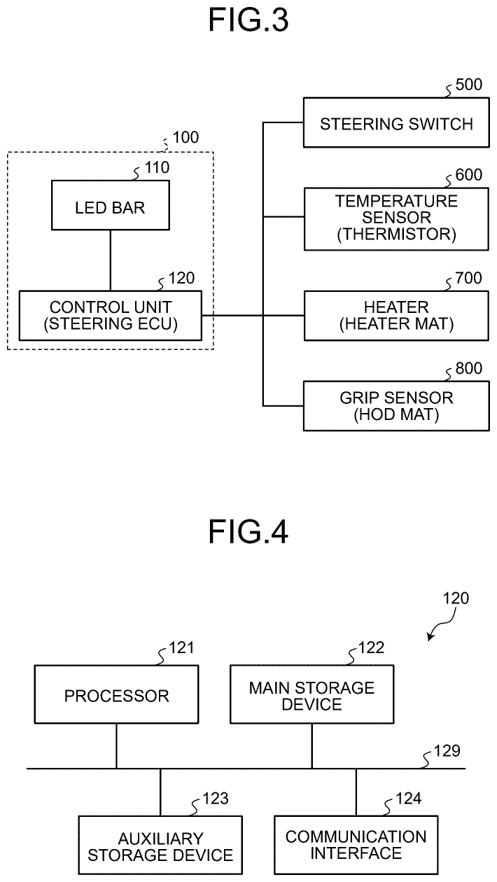

FIG. 3 is a diagram illustrating an example of a configuration of the display device 100 according to the first embodiment. The display device 100 includes an LED bar (light emitting unit, display unit) 110 and a control unit 120 including a steering electronic control unit (ECU) electrically connected to the LED bar 110. The control unit 120 controls the display mode of the LED bar 110 according to the temperature (for example, the current temperature) of the steering wheel 999. In the present embodiment, the display device 100 uses, as a display unit, the LED bar 110 as a light emitting element, but any light emitting element or display element such as a liquid crystal display or a fluorescent lamp may be used as a display unit. A thermistor which is a temperature sensor 600 built in the steering wheel 999, a heater mat which is a heater 700 covering the rim 300, a hands-on detection (HOD) mat which is a grip sensor 800 for detecting a grip of the driver disposed on the steering wheel 999, and the steering switch 500 are similarly connected to the control unit 120 and controlled by the control unit 120. The HOD mat is disposed, for example, wound around the rim 300. The HOD mat includes an electrode provided at a position touched by a person through the skin of the rim 300, and a capacitance sensor that captures a change in capacitance generated between the human body and the electrode.

It is not necessary that all of these components are mounted on the steering wheel 999 at the same time. In addition, another system may be connected. For example, the control unit 120 may not have a timer function 120b to be described later, another timer system may be mounted on the display device 100 or a vehicle on which the display device 100 is mounted, and the timer system may be connected to the control unit 120. In addition, all the systems may not be connected to the same control unit 120, and may be individually connected to each control unit. The control unit 120 may not be disposed on the steering wheel 999, that is, is not limited to the case of being realized by the steering ECU, and each system may be controlled by one integrated ECU that controls the entire vehicle, such as a cockpit domain control unit (CDC). As the control unit 120, a substrate of the steering switch 500 may be used instead of the substrate of the steering ECU, and the design can be appropriately changed as long as the light emitting unit can be controlled according to the temperature. In addition, the heater 700 and the grip sensor 800 are not limited to separate configurations, and may have a dual configuration.

FIG. 4 is a diagram illustrating an example of a hardware configuration of the control unit 120 according to the first embodiment. As illustrated in FIG. 4, the control unit 120 includes at least one processor 121, a main storage device 122, an auxiliary storage device 123, and a communication interface 124, and has a hardware configuration similar to that of a normal computer. The processor 121, the main storage device 122, the auxiliary storage device 123, and the communication interface 124 are communicably connected via, for example, a bus 129.

The at least one processor 121 is, for example, a central processing unit (CPU), but another processor may be provided instead of the CPU or in addition to the CPU. As other processors, various processors such as a CPU, a graphics processing unit (GPU), and a digital signal processor (DSP), a dedicated arithmetic circuit implemented by an application specific integrated circuit (ASIC) and a field programmable gate array (FPGA), and the like can be used as appropriate. The main storage device 122 is a volatile memory such as a random access memory (RAM). The main storage device 122 temporarily stores data necessary for various processes by the processor 121. The auxiliary storage device 123 is a nonvolatile memory such as a read only memory (ROM). The auxiliary storage device 123 stores programs, parameters, and the like that implement various processes by the processor 121. The communication interface 124 is an interface for transmitting and receiving information (control signal and/or data) to and from the outside of the control unit 120. The communication interface 124 communicates with each of the LED bar 110, the steering switch 500, the temperature sensor 600, the heater 700, and the grip sensor 800. Note that the communication interface 124 may transmit and receive information to and from another ECU mounted on the vehicle 1 via an in-vehicle network including a control unit area network (CAN), Ethernet (registered trademark), a universal serial bus (USB (registered trademark), or the like in the vehicle, or may communicate with an information processing device outside the vehicle via a telecommunication line such as the Internet.

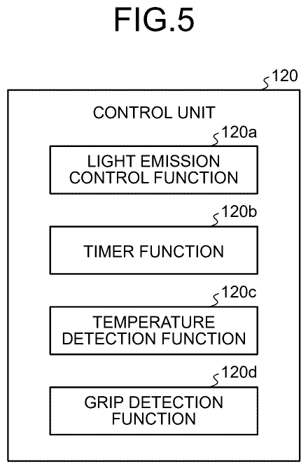

FIG. 5 is a diagram illustrating an example of a functional configuration of the control unit 120 according to the first embodiment. For example, the control unit 120 executes a program loaded from the auxiliary storage device 123 to the main storage device 122 by the processor 121 to implement each function of the control unit 120 including a light emission control function 120a, a timer function 120b, a temperature detection function 120c, and a grip detection function 120d.

The light emission control function 120a controls a light emission mode (display mode) of the LED bar 110. As an example, the light emission control function 120a causes the LED bar 110 to emit light when the heater 700 is turned on. As an example, the light emission control function 120a expresses the temperature state of the steering wheel 999 by controlling the light emission mode of the LED bar 110. For example, the light emission control function 120a causes the LED bar 110 to emit light in a color corresponding to the current temperature of the steering wheel 999. As an example, when a grip of the steering wheel 999 by the driver is detected, the light emission control function 120a turns off the LED bar 110.

The timer function 120b measures an elapsed time from the start of temperature display on the display device 100.

The temperature detection function 120c acquires the current temperature of the steering wheel 999 based on the output of the temperature sensor 600. For example, the current temperature may be acquired by correcting a measurement value based on a positional relationship between a measurement position of temperature sensor 600 such as a thermistor and the grip portion of the steering wheel 999 or a material. Furthermore, the temperature sensor 600 may also be used as a temperature sensor used for temperature control of the heater 700. In other words, the temperature sensor 600 may be used for both the temperature detection of the rim 300 of the steering wheel 999 and the temperature detection of the heater 700.

The grip detection function 120d determines whether the driver grips the steering wheel 999 based on the output of the grip sensor 800 (in the present embodiment, the HOD mat is used). Specifically, the grip detection function 120d determines whether the driver's hand is in contact with the steering wheel 999 based on a change in capacitance detected on the HOD mat.

Note that the grip detection function 120d may determine that the steering wheel is “gripped” the steering wheel 999 in a case where the driver's hand is in contact with the steering wheel for a predetermined time or more, which is predetermined and stored in the auxiliary storage device 123 or the like, for example. Alternatively, the grip detection function 120d may determine that the steering wheel is “gripped” in a case where the driver's hand is in contact with a predetermined place, such as a driving posture, which is determined in advance as a place assumed to be gripped by the driver and stored in the auxiliary storage device 123 or the like. Alternatively, the grip detection function 120d may determine that the steering wheel is “gripped” in a case where it is determined that the driver's hand is in contact with the HOD mat provided at a predetermined place assumed to be gripped by the driver, such as a driving posture.

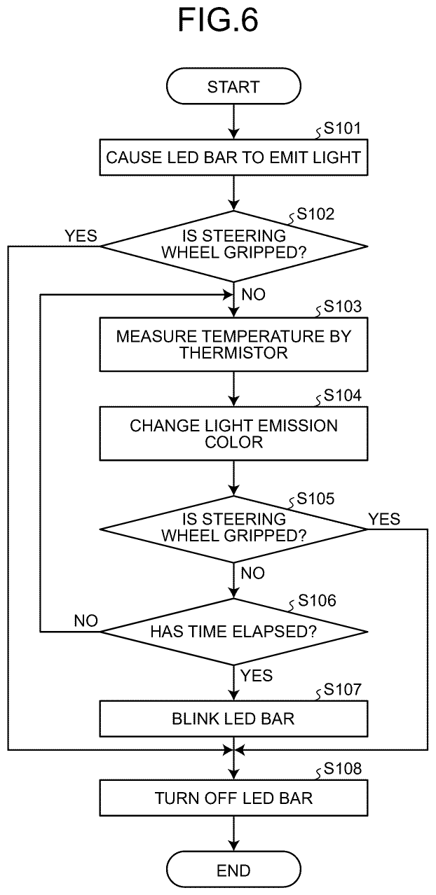

Hereinafter, a processing operation by the control unit 120 of one aspect according to the present disclosure will be described with reference to the drawings. FIG. 6 is a flowchart illustrating an example of processing according to the first embodiment. The display device 100 executes the routine illustrated in FIG. 6 with the ON of the switch of the heater 700 as a trigger. The start of the routine may not be limited to ON and OFF of the heater switch. For example, the display device 100 may start the routine in a case where the door is opened or a case where the door is unlocked, and the routine may be started before the driver grips the steering wheel 999. At this time, the temperature display by the LED bar 110 is performed for a predetermined time. The predetermined time is appropriately determined. The predetermined time is preferably, but not limited to, a time sufficient for the heater 700 to complete heating. As will be described in detail later, the display device 100 may calculate a predetermined time at the start of the routine.

In the control according to the present embodiment, as illustrated in FIG. 6, when the routine is started, in Step S101, the control unit 120 causes the LED bar 110 to emit light and starts counting of the elapsed time from the start of light emission, that is, temperature display.

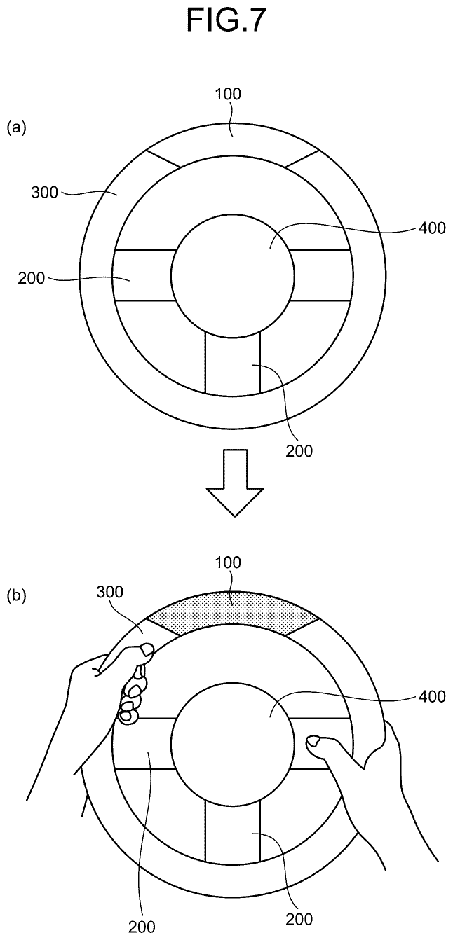

Next, in Step S102, the control unit 120 determines whether the driver grips the steering wheel 999 (steering wheel) on the basis of the grip sensor 800 (in the present embodiment, the HOD mat is used). When it is determined that the driver grips the steering wheel 999 (YES in Step S102), the process proceeds to Step S108, the control unit 120 turns off the LED bar 110, and the display device 100 ends the temperature display in Step S108. A state change of the LED bar 110 when the grip is detected is illustrated in FIG. 7. FIG. 7 is a diagram illustrating an example of behavior of the display device 100 in a case where the steering wheel 999 is gripped according to the first embodiment. As illustrated in (a) of FIG. 7, the display device 100 according to the present embodiment emits light indicating a temperature when the steering wheel 999 is not held by the driver. However, as illustrated in (b) of FIG. 7, in a case where it is detected that the steering wheel 999 is gripped by the driver, light emission of the temperature display is stopped.

Note that, in the control according to one aspect of the present disclosure, regardless of the order of the illustrated flowchart, the grip detection is performed in parallel, and the temperature display ends when the grip is detected in any step. This is because it is not necessary to display the current temperature to the driver after gripping. The display device 100 according to the present embodiment can enable power saving by ending temperature display when grip is detected.

In a case where the control unit 120 determines that the driver does not grip the steering wheel 999 (NO in Step S102), the process proceeds to Step S103. In Step S103, the display device 100 measures the current temperature of the steering wheel 999 using the temperature sensor 600. In Step S104, the control unit 120 causes the LED bar 110 to emit light in a color corresponding to the current temperature obtained in Step S103. The display device 100 can allow the driver to visually recognize the current temperature of the steering wheel 999 by causing the LED bar 110 to emit light in a color corresponding to the current temperature.

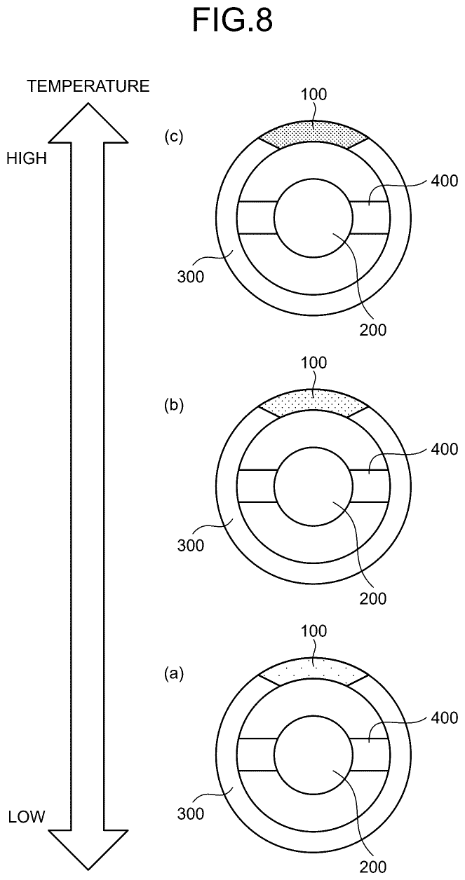

The light emission control corresponding to the current temperature will be specifically described. FIG. 8 is a diagram illustrating how the light emission color of the display device 100 changes according to the first embodiment. (a) to (c) of FIG. 8 illustrate how the light emission color changes according to the current temperature. In the low-temperature state, the light emission color of the LED bar 110 of the display device 100 is a cool color ((a) of FIG. 8) such as light blue. On the other hand, the light emission color becomes a warm color such as yellow or orange as the temperature increases ((b) of FIG. 8). Then, in an appropriate temperature state in which the steering wheel 999 is fully warmed, the light emission color of the LED bar 110 becomes a predetermined specific color such as red ((c) of FIG. 8). The display device 100 presents the current temperature of the rim 300 to the driver by changing the light emission color of the LED bar 110 according to the current temperature as described above. The color change is preferably a stepwise change, but the light emission color of the LED bar 110 may be changed to light blue until the temperature is lowered, and the light emission color may be changed to red when the temperature of the rim 300 is lowered. In addition, the relationship between the temperature and the light emission color is arbitrary, and can be appropriately changed.

Here, the appropriate temperature state in which the steering wheel 999 is fully warmed is a temperature state determined in advance as a target temperature (for example, 38° C.) or a range thereof at which the driver who touches or grips the steering wheel 999 at that temperature does not feel discomfort and stored in the auxiliary storage device 123 or the like. The appropriate temperature state may be defined by any of the output value of the heater 700, the temperature value of the steering wheel 999, and the elapsed time from the start of heating.

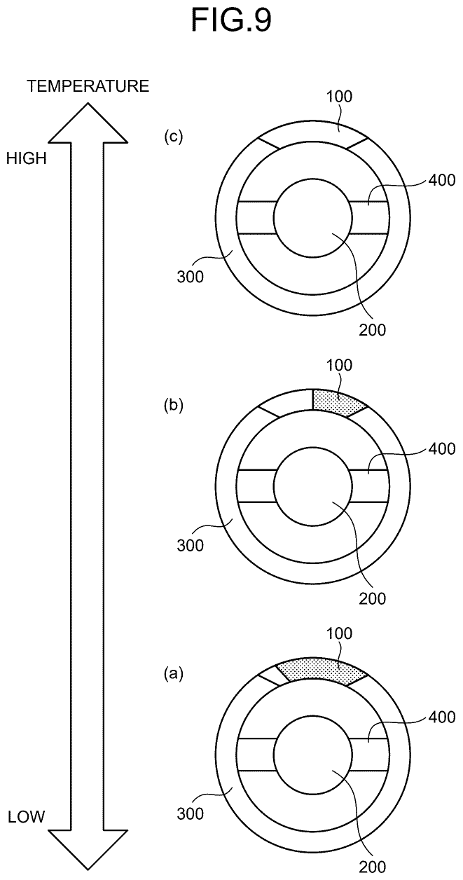

Furthermore, instead of or in addition to the change in the light emission color, a configuration in which the light emission area is changed according to the current temperature is also conceivable. FIG. 9 is a diagram illustrating how the light emission area of the display device 100 changes according to the first embodiment. In the low-temperature state, the light emission area of the LED bar 110 of the display device 100 is, for example, about 10% of the entire area ((a) in FIG. 9), but as the temperature increases, for example, half of the entire area becomes the light emission area ((b) in FIG. 9), and the light emission area of the LED bar 110 becomes equal to the entire area in the appropriate temperature state in which the steering wheel 999 is fully warmed ((c) in FIG. 9). The display device 100 presents the current temperature of the rim 300 to the driver by increasing or decreasing the light emission area of the LED bar 110 according to the current temperature as described above. In the low-temperature state, the light emission area of light blue is larger, but the current temperature may be presented by a color area such as an increase in the light emission area of red as the temperature increases.

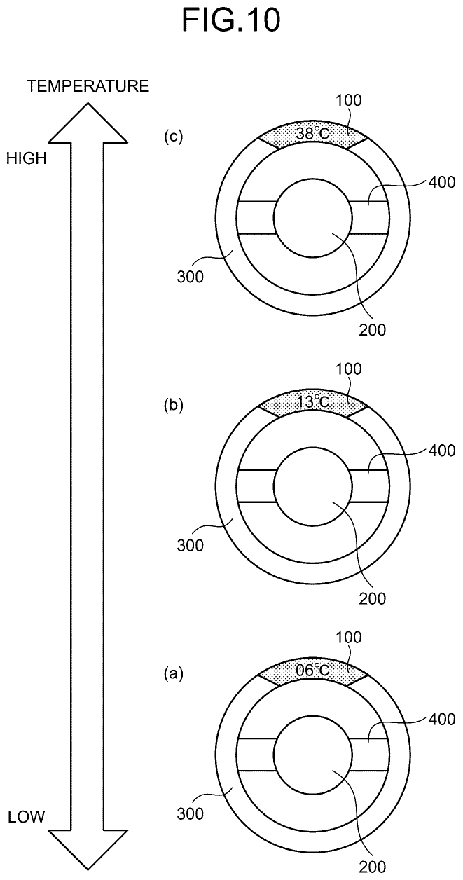

Furthermore, a configuration in which characters displayed on the LED bar 110 are changed according to the current temperature is also conceivable. FIG. 10 is a diagram illustrating a state in which characters to be displayed by light emission of the display device 100 change according to the first embodiment. For example, when the current temperature of the steering wheel 999 is a low temperature such as 6° C., the number displayed on the LED bar 110 of the display device 100 is 06° C. ((a) of FIG. 10). However, as the temperature increases, characters displayed change according to the current temperature such as 13° C. ((b) of FIG. 10). In an appropriate temperature state of, for example, 38° C. where the steering wheel 999 is fully warmed, for example, the LED bar 110 displays characters of 38° C. ((c) of FIG. 10). The display device 100 presents the current temperature of the rim 300 to the driver, for example, by changing characters displayed on the LED bar 110 according to the current temperature as described above. In the appropriate temperature state, the LED bar 110 may display a message or an icon indicating the appropriate temperature state instead of the display of the current temperature. Note that the configuration for changing characters to be displayed may be combined with at least one of the above-described light emission color, light emission area, and color area.

Note that examples of the change in a case where the state of light emission changes according to the current temperature include a change in form, pattern, blinking speed, and the like, and any format may be used as long as the driver can be visually notified of the temperature change. In a case where the blinking speed is changed according to the current temperature, for example, when the current temperature of the steering wheel 999 is a low temperature such as 6° C., the LED bar 110 of the display device 100 is not turned on, but starts blinking when the current temperature rises to 13° C. or the like, the blinking speed becomes faster as the current temperature rises, and in an appropriate temperature state of, for example, 38° C. in which the steering wheel 999 is fully warmed, for example, the LED bar 110 has the fastest blinking speed, or the blinking ends and lights up. In a case where the form or pattern of the light emission is changed, for example, at a low temperature such as 6° C. of the current temperature of the steering wheel 999, the LED bar 110 of the display device 100 is not turned on. However, as the current temperature rises, horizontal lines or vertical lines that emit light at equal intervals are gradually added and displayed. For example, in an appropriate temperature state of 38 degrees, a check pattern is displayed to present to the driver that the temperature is a temperature at which the rim 300 can be held.

In Step S105, the control unit 120 determines whether the driver grips the steering wheel 999 on the basis of the grip sensor 800 (in the present embodiment, the HOD mat is used), as in S102. In a case where it is determined that the driver grips the steering wheel (YES in Step S105), the display device 100 ends the temperature display in a flow similar to the case of YES in Step S102. In a case where it is determined that the driver does not grip the steering wheel (NO in Step S105), the process proceeds to Step S106.

In Step S106, the control unit 120 determines whether a predetermined time has elapsed since the temperature display of the display device 100 has been started. The predetermined time may be determined in advance and stored in the auxiliary storage device 123 or the like by, for example, measuring the correlation with the temperature or calculating the correlation with the temperature on the basis of the material or size of the steering wheel 999, the heating performance of the heater 700, or the like, or may be corrected according to, for example, the ambient temperature or the like. In a case where the predetermined time has not elapsed (NO in Step S106), the process returns to Step S103 to measure the temperature. In a case where the predetermined time has elapsed (YES in Step S106), the control unit 120 blinks the LED bar 110 in Step S107 in order to give a signal to the driver to end the temperature display. Since any format may be used as long as the driver can be notified of the end of the temperature display, at least one of the display color of the display of the LED bar 110, the blinking speed, the display area, and the display pattern may be changed by changing the color to purple instead of blinking. After the end of the temperature display is signaled in Step S107, the LED bar 110 is turned off and the temperature display is turned off in Step S108.

### Modification

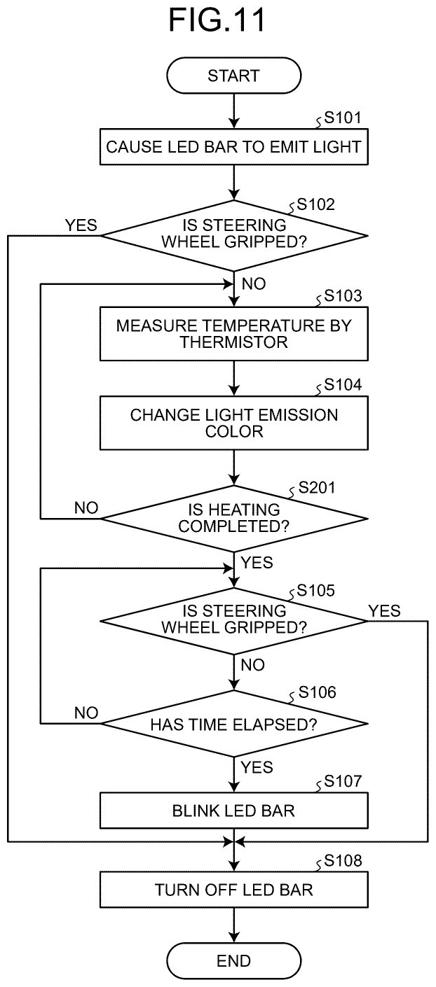

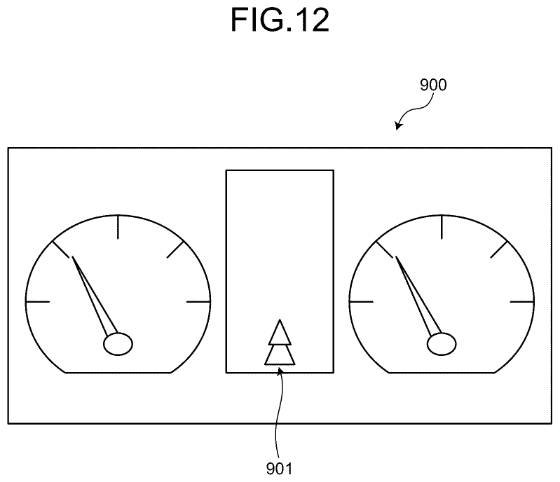

Note that it may be determined whether a predetermined time has elapsed since the heating end is detected, not whether a predetermined time has elapsed since the display device 100 is turned on. FIG. 11 is a flowchart illustrating the operation of the display device 100 in a case where it is determined that a predetermined time has elapsed since the heating is completed according to a modification of the first embodiment. The control having the same content as that in FIG. 6 is denoted by the same reference numeral, and the description thereof will be omitted.

The flowchart of FIG. 11 is obtained by adding Step S201 of heating completion determination for determining whether the current temperature of the steering wheel 999 has reached the target temperature between Step S104 and Step S105 of the flowchart of FIG. 6. Here, the target temperature is a temperature (for example, 38° C.) in an appropriate temperature state in which the steering wheel 999 is fully warmed, and is stored in, for example, the auxiliary storage device 123 set in advance. In a case where it is determined that the temperature measured by the temperature sensor 600 has not reached the target temperature (NO in Step S201), the control unit 120 repeats the temperature measurement in Step S103 and the light emission color change in Step S104. When the temperature measured by the temperature sensor 600 reaches the target temperature and becomes a temperature suitable for gripping the rim 300 of the steering wheel 999 (YES in Step S201), the control unit 120 ends the temperature measurement step and the step of changing the light emission color, starts measurement of the elapsed time from when the temperature measured by the temperature sensor 600 reaches the target temperature, and proceeds to Step S105. Thereafter, in a similar manner to the flow of FIG. 6, the control unit 120 determines whether the steering wheel 999 is gripped by the driver on the basis of the grip sensor 800 in Step S105. In a case where it is determined that the steering wheel is gripped, the process proceeds to Step S108, the LED bar is turned off, and the temperature display is terminated in Step S601. In a case where it is determined that the steering wheel is not gripped, the process proceeds to Step S106, and the display device 100 determines whether a predetermined time has elapsed since the heating is completed in Step S201. In a case where the predetermined time has not elapsed (NO in Step S106), the control unit 120 returns to the determination as to whether the steering wheel 999 is gripped (Step S105) again, and repeats Steps S105 and S106.

In Step S108 of FIG. 6 or 11, after the temperature display is turned off in Step S108, the display device 100 may be used to display another vehicle information. For example, the display device 100 may display the mode state of the automatic driving. Examples of the vehicle information include an in-vehicle air-conditioning state, a vehicle speed, fuel consumption, and the like, but are not limited thereto.

The display of the temperature state is preferably realized by the LED bar 110 disposed on the steering wheel 999, but may be realized by, for example, a meter 900 as illustrated in FIG. 12. For example, the display device 100 may arrange a display symbol 901 that changes the state of light emission according to the current temperature in the meter 900. The display device 100 only needs to be configured to allow the driver to visually recognize the current temperature situation of the steering wheel 999, and the position of the display unit (for example, the LED bar 110) can be freely determined.

### Configuration and Operational Effects of Embodiment

Hereinafter, the configuration of the first embodiment and the operational effects thereof will be described.

The display device 100 according to the first embodiment of the present disclosure includes: the LED bar 110 that is disposed on the steering wheel 999, has one or a plurality of light emitting elements, and emits light to display information; and the control unit 120 that is electrically connected to the LED bar 110 and controls light emission of the LED bar 110 according to a current temperature of the steering wheel 999.

According to the above configuration, the driver can visually check the current temperature situation of the steering without holding the steering wheel 999 with his/her hand. In addition, the display device 100 can be disposed on the steering to allow the driver to recognize the temperature of the steering sensuously and easily.

In the display device 100, the steering wheel 999 includes the temperature sensor 600 that detects a temperature of the steering wheel 999. The control unit 120 treats the temperature detected by the temperature sensor 600 as the current temperature of the steering wheel 999, and controls the operation of the LED bar 110 according to the detected temperature.

According to the above configuration, since the display device 100 detects the current temperature of the steering wheel 999 and controls the LED bar 110 at the temperature corresponding thereto, it is possible to display a more accurate temperature of the steering wheel 999 to the driver. As a result, the driver can more accurately recognize the current temperature of the steering wheel 999.

Furthermore, in the display device 100, the control unit 120 changes at least one of the color of light emission, the blinking speed, the light emission area, and the light emission pattern of the LED bar 110 according to the current temperature of the steering wheel 999.

According to the above configuration, the display device 100 can allow the driver to visually recognize the change in the current temperature situation. As a result, the driver can visually recognize a change in temperature.

In the display device 100, the rim 300 of the steering wheel 999 includes the grip sensor 800 that detects a grip of the rim 300 by the driver. When the grip sensor 800 detects that the driver grips the rim 300, the control unit 120 stops light emission from the LED bar 110.

According to the above configuration, the display device 100 can detect the start of the driving operation of the driver and stop unnecessary temperature display.

In the display device 100, the steering wheel 999 includes the heater 700 that warms the steering wheel 999. When a predetermined time elapses after the heating of the steering wheel 999 by the heater 700 is finished, the control unit 120 stops the light emission for temperature display corresponding to the current temperature by the LED bar 110.

According to the above configuration, it is possible to cause the driver to recognize that the temperature is sufficiently warmed and then stop unnecessary light emission to save power.

In addition, in the display device 100, after the heating of the steering wheel 999 by the heater 700 is finished and a predetermined time has elapsed, the control unit 120 changes at least one of the color of light emission, the blinking speed, the light emission area, and the light emission pattern of the LED bar 110, and then stops light emission by temperature display.

According to the above configuration, the display device 100 can cause the driver to recognize that the display device 100 ends the light emission corresponding to the temperature.

In the display device 100, the LED bar 110 is used to display vehicle information other than the current temperature of the steering wheel 999 while not being used to display the current temperature of the steering wheel 999.

According to the above configuration, a plurality of pieces of vehicle information can be displayed by one light emitting member, and cost can be reduced.

In the display device 100, the temperature sensor 600 is also used to detect the temperature of the rim 300 of the steering wheel 999 and the temperature of the heater 700.

According to the above configuration, the temperature of the heater 700 can be controlled by the control unit 120 by being used for the temperature detection of the heater 700 in addition to the temperature detection of the rim 300, and an effect of accurately displaying the temperature and preventing the high temperature of the steering wheel 999 is obtained. Furthermore, since only one temperature sensor 600 needs to be provided, the cost can be reduced.

In the display device 100, the control unit 120 and the light emitter may be incorporated in the steering switch 500 disposed on the spoke 200 of the steering wheel 999.

According to the above configuration, since the display device 100 can be configured integrally with the steering switch 500, the cost can be reduced as compared with a case where the display device is configured separately.

### Second Embodiment

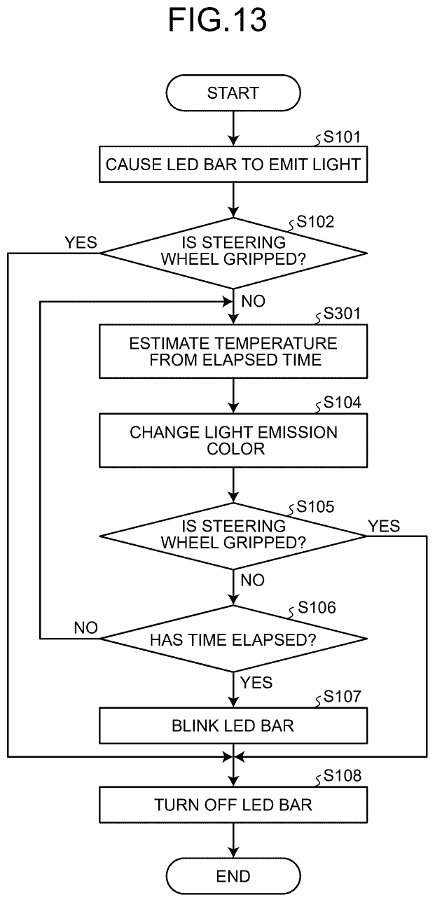

Next, a processing operation of a display device 100 according to a second embodiment of the present disclosure will be described. FIG. 13 is a processing flowchart according to the second embodiment, and illustrates an example of the operation of the display device 100 in a case where the temperature is displayed from the elapsed time. In the following description, parts equivalent to those of the first embodiment are denoted by equivalent reference numerals, and the description thereof may be omitted.

As illustrated in FIG. 13, specifically, the second embodiment is different from the first embodiment in the current temperature detection processing. In the second embodiment, the timer function 120b of the control unit 120 measures the elapsed time after the switch of the heater 700 is turned on. In the display device 100 according to the second embodiment, when the switch of the heater 700 is turned on, the timer function 120b of the control unit 120 starts measuring the elapsed time.

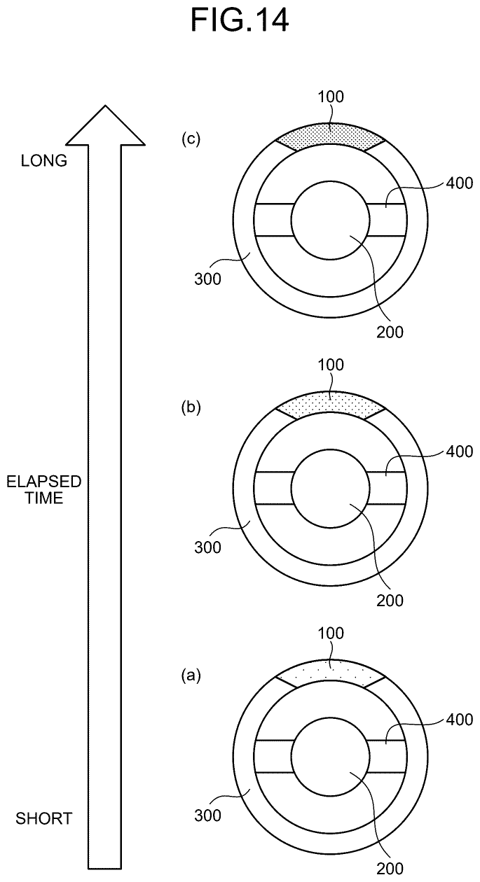

In a case where the steering wheel 999 is not gripped (NO in Step S102), the control unit 120 estimates the current temperature of the steering wheel 999 from the elapsed time in Step S301. For example, the control unit 120 estimates the current temperature using a table or a relational expression indicating the relationship between the elapsed time and the temperature of the steering wheel 999, which is predetermined and stored in the auxiliary storage device 123 or the like. Thereafter, in Step S104, the control unit 120 causes the LED bar 110 to emit light in a color corresponding to the estimated temperature. The control unit 120 repeats Step S301 and steps from Step S104 to Step S106 until the temperature of the steering wheel 999 reaches the value of the elapsed time estimated to have sufficiently increased. FIG. 14 illustrates an example in which the state of light emission of the display device 100 changes with the lapse of time. (a) to (c) of FIG. 14 illustrate a state in which the light emission color changes according to the temperature estimated from the elapsed time. For example, in a case where the estimated temperature is low, such as the elapsed time of 1 sec, the light emission color of the LED bar 110 of the display device 100 is a cool color ((a) of FIG. 14) such as light blue. On the other hand, as the time elapses, in other words, as the estimated temperature increases, the light emission color becomes a warm color such as yellow or orange ((b) of FIG. 14). Then, in a case where a sufficient time has elapsed and the estimated temperature reaches, for example, 38° C. or the like in an appropriate temperature state, the light emission color of the LED bar 110 becomes a predetermined specific color such as red, for example ((c) of FIG. 14). The display device 100 presents the current temperature of the rim 300 to the driver by changing the light emission color of the LED bar 110 according to the temperature estimated from the elapsed time as described above. Note that, without the step of estimating the current temperature, the control unit 120 may use the elapsed time as a temperature index and control the light emission of the LED bar 110 according to the elapsed time. That is, not limited to the case of controlling the light emission mode of the LED bar 110 according to the temperature converted from the elapsed time, the control unit 120 may control the light emission mode of the LED bar 110 according to the elapsed time measured by the timer function 120b of the control unit 120. In this case, the correspondence between the elapsed time and the light emission mode may be determined in advance and stored in the auxiliary storage device 123.

Note that the display device 100 according to the present embodiment can be appropriately combined with the modification of the first embodiment described above. For example, in the flowchart of FIG. 13, the heating completion determination step (Step S201 in FIG. 11) can be performed.

### Configuration and Operational Effects of Embodiment

Hereinafter, the configuration and operational effects of the second embodiment will be described.

In the display device 100 according to the second exemplary embodiment, the steering wheel 999 includes the heater 700 that warms the rim 300. The control unit 120 measures an elapsed time from when the heater 700 is turned on, estimates the temperature of the steering wheel 999 from the elapsed time, and uses the estimated temperature as a current temperature of the steering wheel 999 to control light emission of the LED bar 110.

According to the above configuration, the display device 100 can display the temperature on the basis of the elapsed time without interposing the measurement step by the temperature sensor 600, so that the cost can be reduced. In addition, the driver can visually recognize the current temperature of the steering wheel 999.

### Third Embodiment

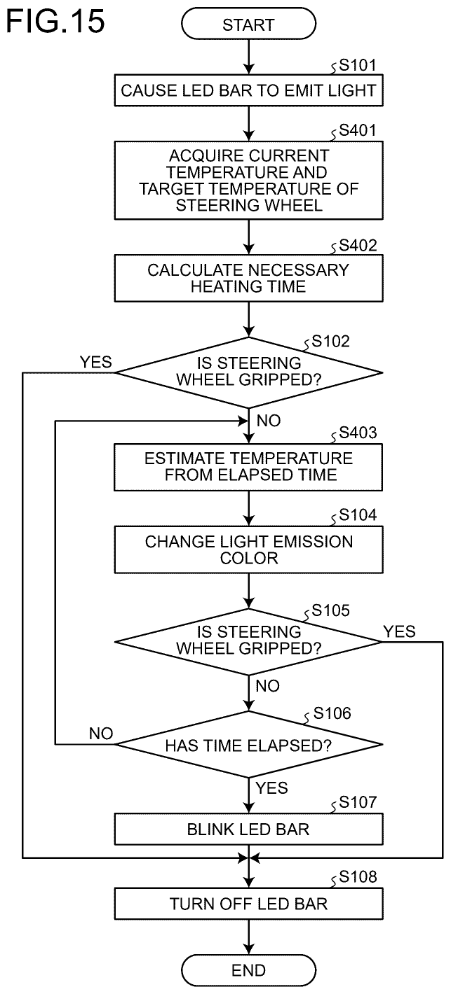

Next, a processing operation according to a third embodiment of the present disclosure will be described. FIG. 15 is a processing flowchart according to the third embodiment, and illustrates an example of the operation of the display device 100 in the case of calculating a heating time. In the following description, description of parts equivalent to those of the above-described embodiment may be omitted.

As illustrated in FIG. 15, specifically, the third embodiment is different from the first embodiment in the amount of change in which the control unit 120 associates the state of light emission. In the third embodiment, the steering wheel 999 includes a temperature sensor 600 that measures the current temperature (temperature when the switch is turned on) of the steering wheel 999. In addition, the timer function 120b of the control unit 120 measures the elapsed time after the switch of the heater 700 is turned on. In the third embodiment, when the processing operation is started by turning on the switch of the heater 700 or the like, the control unit 120 measures the current temperature of the steering wheel 999 in Step S401, and acquires the target temperature of the steering wheel 999 from the auxiliary storage device 123 or the like, for example, as in the above-described embodiment. From the temperature at the time of switching on obtained in Step S401 and the target temperature of the steering wheel 999, in Step S402, the control unit 120 calculates a necessary heating time for reaching the target temperature. In the calculation of the necessary heating time, a table or a relational expression indicating the correspondence among the temperature when the switch is turned on, the target temperature, and the necessary heating time may be used. The table and the relational expression may be measured, or may be calculated based on the material and size of the steering wheel 999, the heating performance of the heater 700, or the like, and may be stored in the auxiliary storage device 123 or the like in advance.

Subsequently, in a case where it is determined that the steering wheel 999 is not gripped (NO in Step S102), the control unit 120 estimates the temperature from the relationship between the elapsed time and the necessary heating time in Step S403. At this time, it is assumed that the current temperature can be estimated by the elapsed time with respect to the necessary heating time. For example, in a case where the temperature of the steering wheel 999 is 0 degrees, the target temperature is 38 degrees, and the necessary heating time is 1 minute when the switch of the heater 700 is turned on, and the elapsed time is 30 seconds, the temperature of the steering wheel 999 is expected to be about 15 degrees. Note that the temperature-time correlation is not limited to this, and is appropriately determined. The control unit 120 estimates the current temperature in Step S403, and controls the state of light emission according to the current temperature estimated in Step S104. The control unit 120 repeats Step S403 and Steps S104 to S106 until the necessary heating time calculated in Step $401 is reached. Instead of performing the lapse determination processing of the predetermined time after the completion of the necessary heating time, the necessary heating time and the predetermined time, or the total time thereof may be calculated in Step S401, and the LED bar 110 may blink when the total time of the necessary heating time and the predetermined time has elapsed.

### Configuration and Operational Effects of Embodiment

Hereinafter, the configuration of the third embodiment and the operational effects thereof will be described.

In the display device 100 according to the third exemplary embodiment, the steering wheel 999 includes the heater 700 that warms the steering wheel 999, and the temperature sensor 600 that detects a temperature of the steering wheel 999. The control unit 120 calculates a heating time required to reach a predetermined temperature from the current temperature detected by the temperature sensor 600, and measures an elapsed time from when the heater 700 is turned on. The control unit 120 calculates the current estimated temperature on the basis of the elapsed time with respect to the necessary heating time, and controls the light emission of the LED bar 110 using the estimated temperature as the current temperature of the steering wheel 999.

According to the above configuration, since the control unit 120 estimates the temperature on the basis of the elapsed time with respect to the necessary heating time, the temperature display using time can be performed more accurately.

### Fourth Embodiment

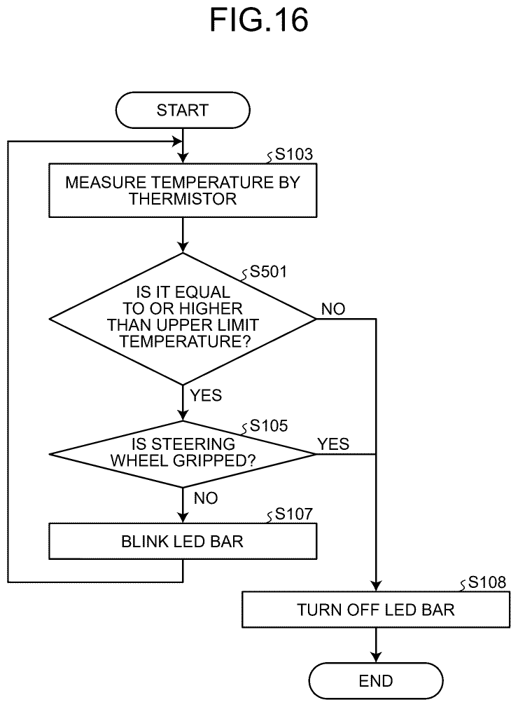

FIG. 16 illustrates an example of a display operation in the summer season of the display device 100 according to the fourth embodiment, that is, a processing operation in a high-temperature state of the steering wheel 999. In the above-described embodiment, the current temperature situation caused by heating is illustrated as the steering wheel 999 is warmed by the heater 700 in a low-temperature environment. However, in a situation where the temperature becomes a temperature at which the steering wheel 999 cannot be held by hand in a high-temperature environment in summer as in the flowchart of FIG. 16, the control unit 120 may perform display until the temperature becomes an appropriate temperature. The control contents will be described below with reference to FIG. 16. In the following description, parts equivalent to those of the first embodiment are denoted by equivalent reference numerals, and the description thereof may be omitted.

The display device 100 starts operation, for example, when a driver opens a door of the vehicle to get on the vehicle. Note that it is only required to start before the driver grips the steering wheel 999, such as a case where the engine is started or a case where the door is unlocked, instead of when the door is opened. In addition, this processing is desirably performed under a hot environment in midsummer. However, this processing may be started at all times when the door is opened, or a calendar function may be mounted on the steering ECU or another ECU, and the operation may be set to start only on a date recognized as summer such as June to August, for example, and can be appropriately changed.

When the process starts, in Step S103, the control unit 120 causes the temperature sensor 600 to measure the current temperature of the steering wheel 999. In Step S501, the control unit 120 determines whether the current temperature of the steering wheel 999 is equal to or higher than the upper limit temperature based on the current temperature obtained in Step S103. The upper limit temperature is a threshold for determining whether the environment is a high-temperature environment in summer, and is predetermined and stored in the auxiliary storage device 123 or the like, for example. As an example, the upper limit temperature may be measured as, for example, a temperature at which the driver cannot directly touch with a hand, or a temperature at which the driver feels discomfort when touching with a hand, or may be calculated on the basis of the material, size, or the like of the steering wheel 999. That is, if the current temperature is equal to or lower than the upper limit temperature (NO in Step S501), it is determined that the temperature display is not necessary, and the control unit 120 ends the temperature display without turning on the LED bar 110. On the other hand, if the temperature is equal to or higher than the upper limit temperature (YES in Step S501), it indicates that the steering wheel 999 is in a high-temperature state, and thus the control unit 120 turns on the LED bar 110.

The subsequent operation is substantially the same as that of the first embodiment, and may blink in red to indicate that the steering wheel 999 is in a high-temperature state, or may display the number of stages of colors such as red→orange→yellow→light blue (warm→cool) every time the temperature cools. In addition, as in the first embodiment, the temperature change is not limited to the color. By changing the light emission color or the like in accordance with the change in the current temperature, it is possible to indicate the temperature state of the steering wheel 999 to the driver and visually avoid a high-temperature state that cannot be directly touched by the hand.

### Configuration and Operational Effects of Embodiment

Hereinafter, the configuration of the fourth embodiment and the operational effects thereof will be described.

In the display device 100 according to the fourth embodiment, in a case where the temperature sensor 600 detects that the temperature of the steering wheel 999 is equal to or higher than the upper limit temperature, the control unit 120 controls the light emission of the LED bar 110 according to the current temperature of the steering wheel 999.

According to the above configuration, the display device 100 can notify the driver that the driver may feel uncomfortable by gripping the steering wheel 999 that cannot be gripped at a high temperature in midsummer, and further, can allow the driver to visually recognize whether the temperature is a graspable temperature. As a result, it is possible to reduce the possibility that the driver feels discomfort by gripping the high-temperature steering wheel.

### Fifth Embodiment

In the first to fourth embodiments described above, a case where it can be determined that driving has started by gripping is exemplified. However, in practice, it is possible to assume a case where the steering wheel is temporarily gripped although the driver does not drive, such as a case where the steering wheel is still cold and the grip is immediately released when the driver sits on the driver's seat and grips the steering wheel. However, when the temperature display is completely ended with the gripping as a trigger in the first to fourth embodiments, there is a possibility that the temperature cannot be grasped even if the steering wheel remains cold after being gripped once.

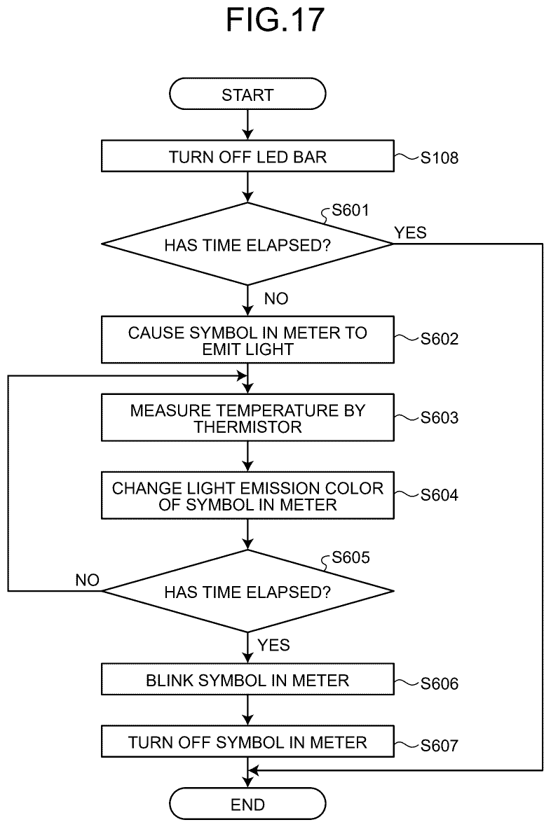

On the other hand, in the fifth embodiment, even when the steering wheel is gripped, the temperature display is continued in a case where the temperature display is required. Next, a processing operation of a display device 100 according to the fifth embodiment of the present disclosure will be described. FIG. 17 is a flowchart illustrating an example of a processing operation of performing actual temperature display on another display unit in a case where a grip of the driver is detected before a predetermined time elapses according to the fifth embodiment.

In the fifth embodiment, even in a case where the LED bar 110 as a first display unit is turned off, if temperature display is required, the temperature display is continued by the in-meter temperature display symbol 901 (display symbols provided in the meter 900 in FIG. 12) as a second display unit. The second display unit may be a temperature display LED provided separately from the first display unit in the vehicle interior. Alternatively, the second display unit may be a temperature display image displayed at a variable position in an arbitrary display in the vehicle interior. The second display unit is disposed at a position where the second display unit is visually recognizable by the user who is able to visually recognize the first display unit. In the fifth embodiment, the in-meter temperature display symbol 901 is arranged in the meter 900 that is visible while the driver viewing the LED bar 110 faces forward.

The flow of FIG. 17 is executed instead of the flow of FIG. 6 in a case where Step S102 or Step S105 in FIG. 6 is YES. That is, in a case where the grip sensor 800 (grip sensor) detects a grip of the steering wheel 999 by the driver in Step S102 or Step S105 in FIG. 6, the flow in FIG. 17 is started. After the processing of S607 of FIG. 17, the flows of FIGS. 6 and 17 end. Note that the flow of FIG. 6 may end when the flow of FIG. 17 starts. Note that the present invention is not limited to the case where the temperature display ends due to the gripping in FIG. 6, and the flowchart of FIG. 17 may be started in a case where the temperature display by the LED bar 110 ends in a state where the steering wheel 999 has not reached the required temperature.

As illustrated in the flowchart of FIG. 6, in a case where the grip sensor 800 detects the grip of the steering wheel 999 by the driver in Steps S102 and S105, the control unit 120 turns off the LED bar 110 (S108).

As illustrated in the flowchart of FIG. 17, after turning off the LED bar 110 in Step S108, the control unit 120 determines whether a predetermined time has elapsed since the temperature display of the display device 100 using the LED bar 110 has been started in S101 of FIG. 6 (S601). In a case where the predetermined time has elapsed (YES in S601), the control unit 120 ends the flowchart illustrated in FIG. 17 and does not display the temperature by the in-meter temperature display symbol 901. In a case where the predetermined time has not elapsed (NO in S601), the control unit 120 causes the in-meter temperature display symbol 901 to emit light (S602). In Step S602, the control unit 120 measures the temperature by the temperature sensor 600 before the in-meter temperature display symbol 901 is caused to emit light, and starts emitting light in the light emission color indicating the current temperature. The predetermined time here is common to the predetermined time used in Step S106 of FIG. 6.

Next, the control unit 120 measures the temperature of the steering wheel 999 using the temperature sensor 600 (Step S603). The control unit 120 changes the light emission color of the in-meter temperature display symbol 901 based on the temperature measured by the temperature sensor 600 (S604).

Thereafter, the control unit 120 determines whether a predetermined time has elapsed since the temperature display of the display device 100 has been started again (S605). In a case where the predetermined time has elapsed (YES in S605), the in-meter temperature display symbol 901 blinks to give notice of the end of the temperature display (S606), and the temperature display by the in-meter temperature display symbol 901 ends (S607). In a case where the predetermined time has not elapsed (NO in S605), the flow returns to Step S603. In a case where the predetermined time has not elapsed, it is considered that the steering wheel 999 is not sufficiently warmed, which corresponds to a case where temperature display is necessary.

With the above control, even in a case where the grip sensor 800 detects the grip of the steering wheel 999 by the driver and the current temperature display of the steering wheel 999 by the LED bar 110 is ended, the current temperature is displayed by other display units such as the in-meter temperature display symbol 901. As a result, even when the temperature display by the LED bar 110 ends, the driver can visually grasp the actual current temperature of the steering wheel 999 by another display unit.

### First Modification

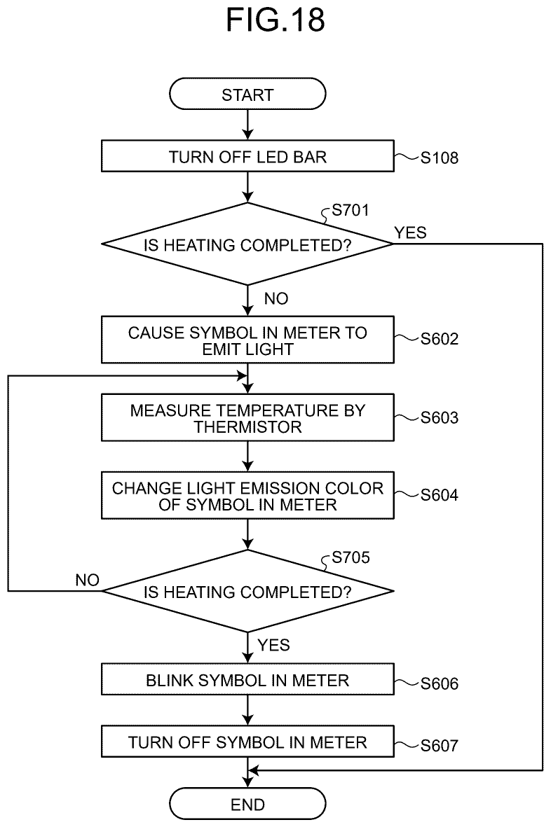

FIG. 18 is a flowchart illustrating an example of a processing operation of performing display on another display unit in a case where a grip of a driver is detected before heating is completed, according to a first modification of the fifth embodiment. The flow of FIG. 18 is executed instead of the flow of FIG. 11 when YES in S102 of FIG. 11. After the processing of S607 of FIG. 18, the flows of FIGS. 11 and 18 end. Note that the flow of FIG. 11 may be ended at the time when the flow of FIG. 18 starts. Specific differences from FIG. 17 include that FIG. 18 is not executed in the case of YES in S105 of FIG. 11, and that the control unit 120 determines that the heating has been completed in FIG. 18 although the control unit determines that the time has elapsed in FIG. 17. In addition, in the drawings, the same reference numerals denote the same or substantially the same configurations, and the description thereof will be appropriately omitted.

In Step S102 of the flowchart of FIG. 11, in a case where the grip of the steering wheel 999 by the driver is detected, the control unit 120 turns off the LED bar (Step S108).

Next, the control unit 120 determines whether the current temperature of the steering wheel 999 reaches the target temperature and the heating is completed (S701). In a case where the heating is completed (YES in S701), the control unit 120 ends the flowchart illustrated in FIG. 18 and does not display the temperature by the in-meter temperature display symbol 901. In a case where the heating is not completed (NO in S701), the control unit 120 causes the in-meter temperature display symbol 901 to emit light instead of the temperature display on the LED bar 110 (S602). In Step S602, the control unit 120 measures the temperature by the temperature sensor 600 before the in-meter temperature display symbol 901 is caused to emit light, and starts emitting light in the light emission color indicating the current temperature.

Next, the control unit 120 measures the temperature of the steering wheel 999 using the temperature sensor 600 (Step S603). The control unit 120 changes the light emission color of the in-meter temperature display symbol 901 based on the temperature measured by the temperature sensor 600 (S604).

Thereafter, the control unit 120 determines whether heating of the steering wheel 999 is completed (S705). In a case where the heating is completed (YES in S705), the in-meter temperature display symbol 901 is blinked to give notice of the end of the temperature display (S606), and the temperature display by the in-meter temperature display symbol 901 is ended (S607). In a case where the heating is not completed (NO in S705), the process returns to Step S603. In a case where the heating is not completed, it is considered that the steering wheel 999 is not sufficiently heated, which corresponds to a case where temperature display is necessary.

### Second Modification

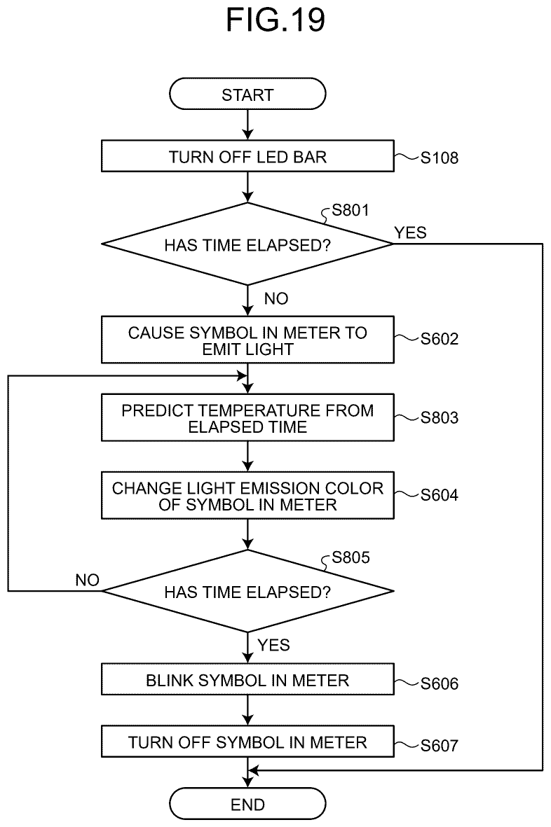

FIG. 19 is a flowchart illustrating an example of a processing operation of displaying a predicted temperature on another display unit in a case where a grip of a driver is detected before a predetermined time elapses according to a second modification of the fifth embodiment. The flow of FIG. 19 is executed instead of the flow of FIGS. 13 and 15 in the case of Yes in S102 or S105 of FIGS. 13 and 15. After the processing of S607 of FIG. 19, the flows of FIGS. 13, 15, and 19 end. Note that the flow of FIG. 13 or FIG. 15 may end when the flow of FIG. 19 starts. A specific difference from FIG. 17 is that the current temperature of the steering wheel 999 is predicted from the elapsed time.

In a case where the grip of the steering wheel 999 by the driver is detected in Steps S102 and S105 of the flowcharts of FIGS. 13 and 15, the control unit 120 turns off the LED bar 110 (Step S108).

Next, the control unit 120 determines whether a predetermined time has elapsed from the start of temperature display on the display device 100 (S801). In a case where the predetermined time has elapsed (YES in S801), the control unit 120 ends the flowchart illustrated in FIG. 19 and does not display the temperature by the in-meter temperature display symbol 901. In a case where the predetermined time has not elapsed (NO in S801), the control unit 120 causes the in-meter temperature display symbol 901 to emit light instead of the temperature display on the LED bar 110 (S602). In Step S602, the control unit 120 predicts the current temperature of the steering wheel 999 from the elapsed time, and starts light emission in the light emission color indicating the current temperature.

Next, the control unit 120 predicts the current temperature of the steering wheel 999 from the elapsed time from the start of the temperature display (Step S803). The control unit 120 changes the light emission color of the in-meter temperature display symbol 901 based on the temperature predicted from the elapsed time (S604).

Thereafter, the control unit 120 determines whether a predetermined time has elapsed since the temperature display of the display device 100 has been started again (S805). In a case where the predetermined time has elapsed (YES in S805), the in-meter temperature display symbol 901 blinks to give notice of the end of the temperature display (S606), and the temperature display by the in-meter temperature display symbol 901 ends (S607). In a case where the predetermined time has not elapsed (NO in S805), the process returns to Step S803. In a case where the predetermined time has not elapsed, it is considered that the steering wheel 999 is not sufficiently warmed, which corresponds to a case where temperature display is necessary.

### Third Modification

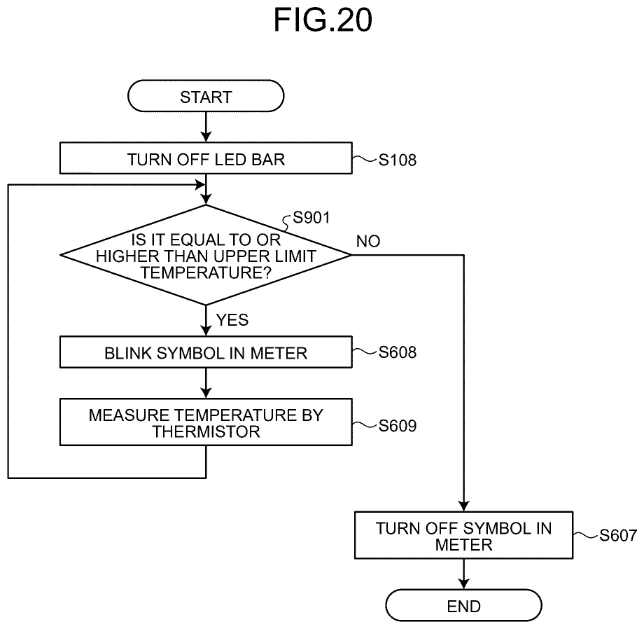

FIG. 20 is a flowchart illustrating an example of a processing operation of performing display on another display unit in a case where a grip of a driver is detected before an upper limit temperature is reached, according to a third modification of the fifth embodiment. The flow of FIG. 20 is executed instead of the flow of FIG. 16 in the case of YES in S105 of FIG. 16. After the processing of S607 of FIG. 20, the flows of FIGS. 16 and 20 end. Note that the flow of FIG. 16 may end at the time when the flow of FIG. 20 starts. A specific difference from FIG. 17 is that light emission of the in-meter temperature display symbol 901 is determined based on whether the current temperature of the steering wheel 999 is equal to or higher than the upper limit temperature.

In Step S105 of the flowchart of FIG. 16, in a case where the grip sensor 800 detects the grip of the steering wheel 999 by the driver, the control unit 120 turns off the LED bar 110 (Step S108).

Next, the control unit 120 determines whether the current temperature of the steering wheel 999 is equal to or higher than the upper limit temperature (S901). In a case where the current temperature of the steering wheel 999 is not equal to or higher than the upper limit temperature (NO in S901), the control unit 120 turns off the in-meter temperature display symbol 901 (S607), then terminates the flowchart illustrated in FIG. 20, and does not display the temperature by the in-meter temperature display symbol 901. In a case where the current temperature of the steering wheel 999 is equal to or higher than the upper limit temperature (YES in S901), the control unit 120 blinks the in-meter temperature display symbol 901 instead of the temperature display on the LED bar 110 (S608).

Next, the control unit 120 causes the temperature sensor 600 to measure the current temperature of the steering wheel 999 (Step S609), returns to Step S901, and repeats Steps S901, S608, and S609 until the current temperature of the steering wheel 999 becomes equal to or lower than the upper limit temperature.

### Configuration and Operational Effects of Embodiment

Hereinafter, the configuration of the fifth embodiment and the operational effects thereof will be described.

The display device 100 according to the fifth embodiment includes an LED bar 110 provided on the steering wheel 999 and an in-meter temperature display symbol 901 disposed at a location different from the LED bar 110 in the vehicle interior. In a case where the temperature of the steering wheel 999 does not reach the target temperature and the display on the LED bar 110 is ended, the control unit 120 performs display according to the temperature using the in-meter temperature display symbol 901.

According to the above configuration, even if the temperature display of the LED bar 110 ends before the steering wheel 999 reaches the target temperature, the current temperature of the steering wheel 999 can be notified to the driver by another display unit such as the in-meter temperature display symbol 901. As a result, the driver can visually recognize the current temperature of the steering wheel 999 even when the temperature display by the LED bar 110 ends.

In addition, the steering wheel 999 includes a grip sensor 800, and in a case where the grip sensor 800 detects the grip of the steering wheel 999 by the driver and the LED bar 110 is turned off, the control unit 120 may display the temperature by the in-meter temperature display symbol 901.

As a result, even if the LED bar 110 is turned off before the temperature reaches the target temperature by the driver's gripping, the in-meter temperature display symbol 901 and the like perform temperature display, so that the driver can visually recognize the current temperature of the steering wheel 999 even when the temperature display by the LED bar 110 ends. The LED bar 110 is used to display the state of a driving assistance device that assists the automatic driving, and the driver can recognize the current temperature by the in-meter temperature display symbol 901.

### Sixth Embodiment

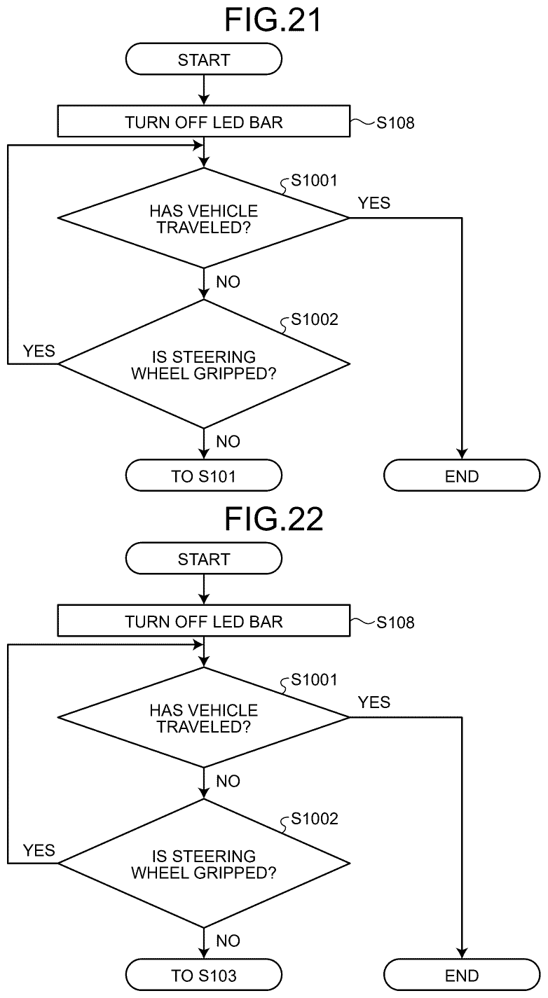

Next, a processing operation of a display device 100 according to a sixth embodiment of the present disclosure will be described. FIG. 21 is a flowchart illustrating an example of a processing operation of confirming whether a vehicle has traveled in a case where displaying on the display unit is stopped according to the sixth embodiment. The flow of FIG. 21 is executed instead of the flow of FIG. 16, for example, in a case where the LED bar is turned off in S102 or S105 of the flowchart of FIG. 6.

In the sixth embodiment, in the first to fourth embodiments, in a case where the grip sensor 800 detects the grip and cannot confirm the traveling of the vehicle even if the temperature display of the LED bar 110 (display unit) stops, the grip sensor performs the display according to the temperature by the LED bar 110 again. Note that the processing operation according to the sixth embodiment can be executed in parallel, for example, in combination with the processing operation according to the fifth embodiment. In addition, in the sixth embodiment, the temperature display after the restart in a case where the traveling cannot be confirmed after the gripping is not limited to the case of being performed by the LED bar 110 (first display unit), and may be performed by another display unit such as the in-meter temperature display symbol 901 (second display unit).

The sixth embodiment will be described below with reference to FIG. 21.

FIG. 21 is a flowchart illustrating an example of a processing operation of resuming the temperature display by the display device 100 again in a case where the traveling state cannot be confirmed after the grip of the driver is detected in the first embodiment illustrated in FIG. 6. In the sixth embodiment, the temperature display by the LED bar 110 is resumed. Note that the present invention is not limited to the case where the temperature display ends due to the gripping in FIG. 6, and the flowchart of FIG. 21 may be started in a case where the temperature display by the LED bar 110 ends in a state where the steering wheel 999 has not reached the required temperature.

In a case where the grip of the steering wheel 999 by the driver is detected in Step S102 or S105 of the flowchart of FIG. 6, the control unit 120 turns off the LED bar 110 (Step S108).

After Step S108, as illustrated in FIG. 21, the control unit 120 determines whether the vehicle has traveled (S1001). In a case where it is determined that the vehicle has traveled (YES in S1001), the flows of FIGS. 6 and 21 are ended.

As means for confirming the traveling state of the vehicle in Step S1001, it is conceivable to acquire GPS information from the start of the flowchart of FIGS. 6 to S1001 and determine that the vehicle has never traveled if there is no change in the position of the vehicle. In addition, in S1001 of FIG. 21, GPS information is acquired for a certain period, and if there is no change in the position of the vehicle, it can be determined that the vehicle has never traveled. Furthermore, for example, the speed of the vehicle is acquired by a vehicle speed sensor or the like provided in the vehicle, and if the speed has never changed from 0 km/s after the start of the flowchart of FIG. 21, it can be determined that the vehicle has never traveled. If the speed or the moving distance of the vehicle is less than a threshold, it may be determined that the vehicle has never traveled. The method for determining the traveling state is not limited to these, and a known technique may be used. Note that the determination of the traveling state may be started after the ignition is turned on and before the flowchart of FIG. 6 is started.

In a case where it is determined in Step S1001 that the vehicle is not traveling (NO in S1001), next, the control unit 120 detects whether the current driver grips the steering wheel 999 by the grip sensor 800 (S1002). In a case where the steering wheel is gripped (YES in S1002), the process returns to Step S1001, and the traveling state is determined again. In a case where the steering wheel is not gripped (NO in S1002), it is determined that the temperature display of the LED bar 110 can be performed, the flow of FIG. 21 is terminated, the flow returns to the flow of S101 of FIG. 6, and the flowchart of FIG. 6 is executed again.

In the above configuration, the processing operation in which the flowchart of FIG. 21 is executed in a case where the LED bar is turned off in S102 or S105 of the flowchart of FIG. 6 is described, but the present invention is not limited thereto. For example, in the case of YES in Step S102 of FIG. 11 (in a case where the grip of the steering is detected before the heating is completed), the processing operation of FIG. 21 may be executed. In the case of YES in Step S102 or S105 of the flowcharts in FIGS. 13 and 15 (the grip of the steering is detected before the predetermined time elapses), the processing operation in FIG. 21 may be executed.

### Modification

In addition, in S105 of the flowchart of FIG. 16, in a case where the grip of the steering wheel 999 by the driver is detected, the processing operation of the sixth embodiment may be performed. FIG. 22 is a flowchart illustrating another example of a processing operation of confirming whether a vehicle has traveled in a case where displaying on the LED bar 110 is stopped according to a modification of the sixth embodiment. The flow of FIG. 22 is executed instead of the flow of FIG. 16 in the case of YES in S105 of FIG. 16. In the modification of the sixth embodiment, in a case where the traveling of the vehicle cannot be confirmed (NO in $1001) and it is determined that the driver does not grip the steering wheel 999 (NO in S1002), the flow of FIG. 22 is ended, and the processing returns to S103 of FIG. 16.

Configuration and Operational Effects of Embodiment Hereinafter, the configuration of the sixth embodiment and the operational effects thereof will be described.

The display device 100 according to the sixth exemplary embodiment includes the LED bar 110 provided on the steering wheel 999 and the control unit 120. In a case where the temperature of the steering wheel 999 does not reach the target temperature and the display corresponding to the temperature by the LED bar 110 (display unit) stops, the control unit 120 checks the traveling state of the vehicle. In a case where the traveling of the vehicle cannot be detected, the control unit 120 performs display according to the temperature by the LED bar 110.

According to the above configuration, the display device 100 restarts the temperature display using the LED bar 110 in a case where the vehicle is not traveling even when the temperature display is once stopped without the steering wheel 999 reaching the target temperature. As a result, in a case where the vehicle is not traveling, the LED bar 110 provided in the steering device displays the temperature again, so that the driver can visually and intuitively grasp the current temperature of the steering wheel 999 even when the LED bar 110 once stops the temperature display.

The steering wheel 999 includes a grip sensor 800. Further, in a case where the control unit 120 cannot detect the traveling of the vehicle even if the temperature display of the LED bar 110 stops due to the grip sensor 800 detecting the grip, the control unit performs display according to the temperature by the LED bar 110.

According to the above configuration, even in a case where the grip sensor 800 detects the grip of the steering wheel 999 by the driver and stops the temperature display by the LED bar 110, when the vehicle is not traveling, the display device 100 starts the temperature display by the LED bar 110 again. As a result, for example, even in a case where the driver grips the steering wheel 999 once and the LED bar 110 stops the temperature display, the driver can visually and intuitively grasp the current temperature of the steering wheel 999 if the driver is not traveling.

Further, in a case where the travel of the vehicle cannot be detected and the driver does not grip the steering wheel 999 even if the temperature display of the LED bar 110 is stopped due to the grip sensor 800 detecting the grip, the control unit 120 performs display according to the temperature by the LED bar 110.

According to the above configuration, in a case where the driver releases his/her hand from the steering wheel 999 without driving the vehicle even if the grip sensor 800 detects the grip of the steering wheel 999 by the driver and stops the temperature display by the LED bar 110, the display device 100 resumes the temperature display by the LED bar 110. As a result, the display device 100 can confirm that the driver does not have the will to drive according to the traveling state and the gripping state even if the driver grips the steering wheel 999 once, for example, and in a case where the driver does not have the will to drive, the current temperature of the steering wheel 999 can be visually and intuitively grasped again by the LED bar 110.

The display device 100 according to the present disclosure is applicable to any moving object including the above-described vehicle. Examples of the mobile object include a ship, an aircraft, a drone, a robot, and a vehicle. The vehicle may be, for example, a passenger car, a cargo vehicle, a vehicle, a motorcycle, an electric kick board, a construction machine, an agricultural machine, an aircraft, or the like.

In the above-described embodiment, “determining whether it is A” may be “determining that it is A”, “determining whether it is not A”, or “determining both it is A and it is not A”.

The program executed by the control unit 120 of the above-described embodiment may be provided by being recorded in a computer-readable recording medium such as a CD-ROM, an FD, a CD-R, a DVD, or an SD card as a file in an installable format or an executable format.

Furthermore, the program executed by the control unit 120 according to the above-described embodiment may be stored on a computer connected to a network such as the Internet and provided by being downloaded via the network. Furthermore, the program executed by the control unit 120 may be provided or distributed via a network such as the Internet.

In addition, the program executed by the control unit 120 of the above-described embodiment may be provided by being incorporated in a ROM or the like in advance.

In addition, the program executed by the control unit 120 of the above-described embodiment has a module configuration including the above-described functions, and as actual hardware, the processor 121 reads and executes the program from the auxiliary storage device 123 or the like, so that functional units that implement the above-described functions are loaded on the main storage device 122, and the above-described functional units are generated on the main storage device 122.

According to at least one embodiment described above, it is possible to allow the driver to recognize the current temperature situation of the steering wheel 999 and improve the convenience of the driver.

The display device according to the present disclosure enables a driver to recognize the current temperature situation of the steering wheel, thereby improving the convenience of the driver.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplementary Note

The following technique is disclosed by the above description of the embodiments.

(1)

A display device includes:
a display unit disposed on an operation unit of a steering device; and
a control unit electrically connected to the display unit, the control unit being configured to control a display mode of the display unit according to a temperature of the operation unit.

(2)

In the display device according to (1),
a grip portion of the operation unit includes a grip sensor configured to detect a grip of the grip portion by a user, and
the control unit is configured to stop displaying by the display unit according to a temperature when the grip sensor detects the grip.

(3)

In the display device according to (1) or (2),
the operation unit includes a heater configured to warm a grip portion of the operation unit that is gripped by a user, and
the control unit is configured to stop displaying by the display unit according to a temperature when a predetermined time has elapsed after the heater finishes heating the operation unit.

(4)

In the display device according to any one of (1) to (3),
the operation unit includes a temperature sensor configured to detect a temperature of the operation unit, and
the control unit is configured to set the temperature detected by the temperature sensor as the temperature of the operation unit.

(5)

In the display device according to any one of (1) to (3),
the operation unit includes a heater configured to warm a grip portion of the operation unit that is gripped by a user, and
the control unit is configured to measure an elapsed time from when the heater is turned on, and estimate the temperature of the operation unit according to the elapsed time.

(6)

In the display device according to any one of (1) to (3),
the operation unit includes a heater configured to warm a grip portion of the operation unit that is gripped by a user, and
the control unit is configured to measure an elapsed time from when the heater is turned on, and use the elapsed time as the temperature of the operation unit.

(7)

In the display device according to any one of (1) to (3),
the operation unit includes a heater configured to warm a grip portion of the operation unit that is gripped by a user, and
the control unit is configured to measure an elapsed time from when the heater is turned on, determine a required heating time from a target temperature, and set a temperature estimated by the elapsed time with respect to the required heating time as the temperature of the operation unit.

(8)

In the display device according to any one of (1) to (7),
the control unit is configured to change at least one of a display color, a blinking speed, a display area, and a display pattern of the display unit as control of the display mode according to the temperature of the operation unit.

(9)

In the display device according to (3) or any one of (4) to (8) according to at least (3),
the control unit is configured to stop displaying according to a temperature by the display unit after the predetermined time has elapsed and after at least one of a display color, a blinking speed, a display area, and a display pattern of the display unit is changed.

(10)

In the display device according to (2), (3), or any one of (4) to (9) according to at least (2) or (3),
the display unit is used to display vehicle information other than the temperature of the operation unit while displaying according to the temperature of the operation unit is not performed.

(11)

In the display device according to (4) or any one of (8) to (10) according to at least (4),
the control unit is configured to control displaying on the display unit according to the temperature of the operation unit when the temperature sensor detects that the temperature of the operation unit is equal to or higher than an upper limit temperature.

(12)

In the display device according to (4) or any one of (8) to (11) according to at least (4),
the operation unit includes a heater configured to warm a grip portion of the operation unit that is gripped by a user, and
the temperature sensor is used for both temperature detection of the grip portion and temperature detection of the heater.

(13)

In the display device according to any one of (1) to (12),
at least one of the control unit and the display unit is built in a steering switch disposed on a spoke of the operation unit.

(14)

In the display device according to any one of (1) to (13),
the control unit is configured to start control of the display mode of the display unit according to the temperature of the operation unit when a heater configured to warm a grip portion of the operation unit gripped by a user is turned on or when a door of a mobile object on which the steering device is mounted is opened.

(15)

A display method executed by a control unit that is disposed in an operation unit of a steering device mounted on a vehicle and is electrically connected to a display unit disposed on the operation unit, the method includes:
measuring a temperature of the operation unit; and
controlling a display mode of the display unit according to a temperature of the operation unit.

(16)

In the display method according to (15), further includes:
measuring an elapsed time from when a switch of a heater configured to warm a grip portion of the operation unit gripped by a user is turned on, in which
the controlling the display mode includes controlling the display unit according to a temperature corresponding to the elapsed time.

(17)

In the display method according to (15), further includes:
measuring an elapsed time from when a switch of a heater configured to warm a grip portion of the operation unit gripped by a user is turned on; and
calculating a heating time required to reach a target temperature from a temperature when the switch of the heater configured to warm the grip portion is turned on, in which
the controlling the display mode includes controlling the display unit according to a temperature estimated by the elapsed time with respect to the required heating time.

(18)

In the display method according to any one of (15) to (17),
the controlling the display mode includes changing at least one of a display color, a blinking speed, a display area, and a display pattern of the display unit according to the temperature of the operation unit.

(19)

A display device includes:
at least one processor; and
a memory that stores at least one program executed by at least the one processor, in which
at least the one processor is configured to implement the display method according to any one of (15) to (18) by executing at least the one program.

(20)

A program for causing a computer to execute the display method according to any one of (15) to (18).

(21)

A recording medium (Computer Program Product) having stored therein the program according to (20) executed by a computer.

(22)

In the display device according to any one of (1) to (14),
the display unit disposed on the operation unit of the steering device is set as a first display unit, and
when the temperature of the operation unit does not reach a target temperature and displaying on the first display unit is stopped, the control unit is configured to perform displaying according to a temperature on a second display unit disposed at a place different from the first display unit in a vehicle interior.

(23)

In the display device according to (3),
a grip portion of the operation unit includes a grip sensor configured to detect a grip of the grip portion by a user,
the display unit disposed on the operation unit of the steering device is set as a first display unit, and
the control unit is configured to: stop, when the grip sensor detects the grip, displaying by the first display unit according to a temperature; and perform, when the temperature of the operation unit does not reach a target temperature and the grip sensor detects the grip to stop the displaying by the first display unit according to the temperature, displaying according to a temperature on a second display unit disposed at a location different from the first display unit in a vehicle interior.

(24)

In the display device according to (22) or (23),
the second display unit is disposed at a position where the second display unit is visually recognizable by a user who is able to visually recognize the first display unit.

(25)

In the display device according to any one of (1) to (14) and (22) to (24),
when the temperature of the operation unit does not reach a target temperature and displaying by the display unit according to the temperature is stopped, the control unit is configured to resume the displaying by the display unit according to the temperature when traveling of a mobile object on which the steering device is mounted is not able to be detected.

(26)

In the display device according to (3),
a grip portion of the operation unit includes a grip sensor configured to detect a grip of the grip portion by a user, and
when the temperature of the operation unit does not reach a target temperature and the grip sensor detects the grip to stop temperature displaying on the display unit, the control unit is configured to resume the displaying by the display unit according to the temperature when traveling of a mobile object on which the steering device is mounted is not able to be detected.

(27)

In the display device according to (2) or (26),
the control unit is configured to further resume the displaying by the display unit according to the temperature when it is determined that the user does not grip the grip portion.

What is claimed is:

1. A display device comprising:
a display unit disposed on an operation unit of a steering device; and
a control unit electrically connected to the display unit, the control unit being configured to control a display mode of the display unit according to a temperature of the operation unit.

2. The display device according to claim 1, wherein
a grip portion of the operation unit includes a grip sensor configured to detect a grip of the grip portion by a user, and
the control unit is configured to stop displaying by the display unit according to a temperature when the grip sensor detects the grip.

3. The display device according to claim 1, wherein
the operation unit includes a heater configured to warm a grip portion of the operation unit that is gripped by a user, and
the control unit is configured to stop displaying by the display unit according to a temperature when a predetermined time has elapsed after the heater finishes heating the operation unit.

4. The display device according to claim 1, wherein
the operation unit includes a temperature sensor configured to detect a temperature of the operation unit, and
the control unit is configured to set the temperature detected by the temperature sensor as the temperature of the operation unit.

5. The display device according to claim 1, wherein
the operation unit includes a heater configured to warm a grip portion of the operation unit that is gripped by a user, and
the control unit is configured to measure an elapsed time from when the heater is turned on, and estimate the temperature of the operation unit according to the elapsed time.

6. The display device according to claim 1, wherein
the operation unit includes a heater configured to warm a grip portion of the operation unit that is gripped by a user, and
the control unit is configured to measure an elapsed time from when the heater is turned on, and use the elapsed time as the temperature of the operation unit.

7. The display device according to claim 1, wherein
the operation unit includes a heater configured to warm a grip portion of the operation unit that is gripped by a user, and
the control unit is configured to measure an elapsed time from when the heater is turned on, determine a required heating time from a target temperature, and set a temperature estimated by the elapsed time with respect to the required heating time as the temperature of the operation unit.

8. The display device according to claim 1, wherein
the control unit is configured to change at least one of a display color, a blinking speed, a display area, and a display pattern of the display unit as control of the display mode according to the temperature of the operation unit.

9. The display device according to claim 3, wherein
the control unit is configured to stop displaying according to a temperature by the display unit after the predetermined time has elapsed and after at least one of a display color, a blinking speed, a display area, and a display pattern of the display unit is changed.

10. The display device according to claim 2, wherein
the display unit is used to display vehicle information other than the temperature of the operation unit while displaying according to the temperature of the operation unit is not performed.

11. The display device according to claim 1, wherein
at least one of the control unit and the display unit is built in a steering switch disposed on a spoke of the operation unit.

12. The display device according to claim 1, wherein
the control unit is configured to start control of the display mode of the display unit according to the temperature of the operation unit when a heater configured to warm a grip portion of the operation unit gripped by a user is turned on or when a door of a mobile object on which the steering device is mounted is opened.

13. The display device according to claim 1, wherein
the display unit disposed on the operation unit of the steering device is set as a first display unit, and
when the temperature of the operation unit does not reach a target temperature and displaying on the first display unit is stopped, the control unit is configured to perform displaying according to a temperature on a second display unit disposed at a place different from the first display unit in a vehicle interior.

14. The display device according to claim 3, wherein
a grip portion of the operation unit includes a grip sensor configured to detect a grip of the grip portion by a user,
the display unit disposed on the operation unit of the steering device is set as a first display unit, and
the control unit is configured to: stop, when the grip sensor detects the grip, displaying by the first display unit according to a temperature; and perform, when the temperature of the operation unit does not reach a target temperature and the grip sensor detects the grip to stop the displaying by the first display unit according to the temperature, displaying according to a temperature on a second display unit disposed at a location different from the first display unit in a vehicle interior.

15. The display device according to claim 1, wherein
when the temperature of the operation unit does not reach a target temperature and displaying by the display unit according to the temperature is stopped, the control unit is configured to resume the displaying by the display unit according to the temperature when traveling of a mobile object on which the steering device is mounted is not able to be detected.

16. The display device according to claim 3, wherein
a grip portion of the operation unit includes a grip sensor configured to detect a grip of the grip portion by a user, and
when the temperature of the operation unit does not reach a target temperature and the grip sensor detects the grip to stop temperature displaying on the display unit, the control unit is configured to resume the displaying by the display unit according to the temperature when traveling of a mobile object on which the steering device is mounted is not able to be detected.

17. The display device according to claim 2, wherein
the control unit is configured to further resume the displaying by the display unit according to the temperature when it is determined that the user does not grip the grip portion.

18. A display method executed by a control unit that is disposed in an operation unit of a steering device mounted on a vehicle and is electrically connected to a display unit disposed on the operation unit, the method comprising:
measuring a temperature of the operation unit; and
controlling a display mode of the display unit according to a temperature of the operation unit.

19. The display method according to claim 18, further comprising:
measuring an elapsed time from when a switch of a heater configured to warm a grip portion of the operation unit gripped by a user is turned on, wherein
the controlling the display mode includes controlling the display unit according to a temperature corresponding to the elapsed time.

20. The display method according to claim 18, further comprising:
measuring an elapsed time from when a switch of a heater configured to warm a grip portion of the operation unit gripped by a user is turned on; and
calculating a heating time required to reach a target temperature from a temperature when the switch of the heater configured to warm the grip portion is turned on, wherein
the controlling the display mode includes controlling the display unit according to a temperature estimated by the elapsed time with respect to the required heating time.
